(19) United States
(12) Patent Application Publication
(10) Pub. No.: US 2012/0320144 A1
(43) Pub. Date: Dec. 20, 2012

(54) VIDEO MODIFICATION SYSTEM AND METHOD

(76) Inventors: Ramin Samadani, Palo Alto, CA (US); Carl Staelin, Haifa N.A. (IL); Darryl Greig, Fishponds Bristol (GB)

(21) Appl. No.: 13/164,492

(22) Filed: Jun. 20, 2011

(51) Int. Cl. H04N 7/14

(52) U.S. Cl. 348/14.08; 348/E07.083

(57) ABSTRACT

A system for coordinating image characteristics in a plurality (n) of video streams, the system includes human factor value determination component, a human factor value comparator component, a human factor modification component. The human factor modification component determines the value of at least the human perceptible factor for at least a subset of the plurality of video streams. The human factor value comparator component compares the value of the at least one human perceptible factor for each of the at least a subset of n video streams. The human factor modification component modifies the value of the human perceptible factor for the at least a subset of the n video streams to minimize the differences in the values of the human perceptible factors between the n independently captured video streams.

### BACKGROUND

A goal of multi-way video conferencing systems is to provide a natural interaction experience which attempts to simulate a meeting as if all the participants are meeting in the same room. In some higher end video conferencing systems, the system attempts to control the physical environment by using the same cameras, paint, lighting, etc. in order to provide a more natural viewing experience. Unfortunately, even in these controlled settings, differences in lighting conditions, camera settings, paint tolerances etc. can result in undesired differences in the video streams and thus in the appearance of the participants. In lower end video conferencing solutions (desktop to desktop and also mobile video conferencing solutions), controlling the physical environment to minimize the differences in the video streams is not practical solution. Since humans are very sensitive to such differences, these differences tend to disrupt the video conference experience.

### BRIEF DESCRIPTION OF DRAWINGS

The figures depict implementations/embodiments of the invention and not the invention itself. Some embodiments are described, by way of example, with respect to the following Figures.

FIG. 1A illustrates a block diagram of a video modification system for processing a plurality of independently captured video streams in a multi-way video conference according to an embodiment of the invention;

FIG. 1B illustrates a block diagram of an alternative embodiment of the video modification system shown in FIG. 1A where the coordinated video modification component is stored locally;

FIG. 1C illustrates a block diagram of an alternative embodiment of the video modification system shown in FIG. 1B where only a subset of the video streams is displayed on one of the participant's display screens;

FIG. 2A illustrates a flow diagram of a method of balancing human perceptible image quality factors of independently captured video streams in a multi-way video conference according to an embodiment of the present invention;

FIG. 2B illustrates a flow diagram of a method of modifying the color balance in a multi-way video conference according to an embodiment of the present invention;

FIG. 2C illustrates a flow diagram of a method of modifying the color balance of independently captured video streams in a multi-way video conference according to an embodiment of the present invention;

FIG. 2D illustrates a flow diagram of a method of modifying captured video streams in a multi-way video conference when an improved aesthetic is specified according to an embodiment of the present invention;

FIG. 3 shows a computer system for implementing the method shown in FIGS. 2A-2D described in accordance with embodiments of the present invention.

The drawings referred to in this Brief Description should not be understood as being drawn to scale unless specifically noted.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It will be apparent, however, to one of ordinary skill in the art, that the embodiments may be practiced without limitation to these specific details. Also, different embodiments may be used together. In some instances, well known methods and structures have not been described in detail so as not to unnecessarily obscure the description of the embodiments.

Multi-way video conferencing systems aim to provide a natural experience to the participants, providing a conference environment which simulates the experience of a meeting where all the participants are meeting in the same physical location. Unfortunately, differences in camera settings, lighting conditions, etc. at the sites of the different locations can result in substantial undesired differences in the appearance of the participants. Since humans are very sensitive to such differences, they tend to disrupt the user experience. The invention describes a multi-way video coordination and modification system that samples the multiple video streams and more closely matches human perceptible factors (color balance, contrast, etc.) between the video streams in order to provide more consistent video streams with respect to the human perceptible factors thus providing a more natural interaction environment.

The video modification system 112 is comprised of: a human factor value determination component 102, for determining the value of at least the human perceptible factor for at least a subset of the plurality of video streams 104a-n, wherein the plurality of video streams 104a-n are each captured independently by at least n image capture devices 106a-n; a human factor value comparator component 120 for comparing the value of the at least one human perceptible factor for the at least a subset of the n video streams; and a human factor modification component 124 for modifying the value of the human perceptible factor for the at least a subset of the n video streams to minimize the differences in the values of the human perceptible factor between the n video streams.

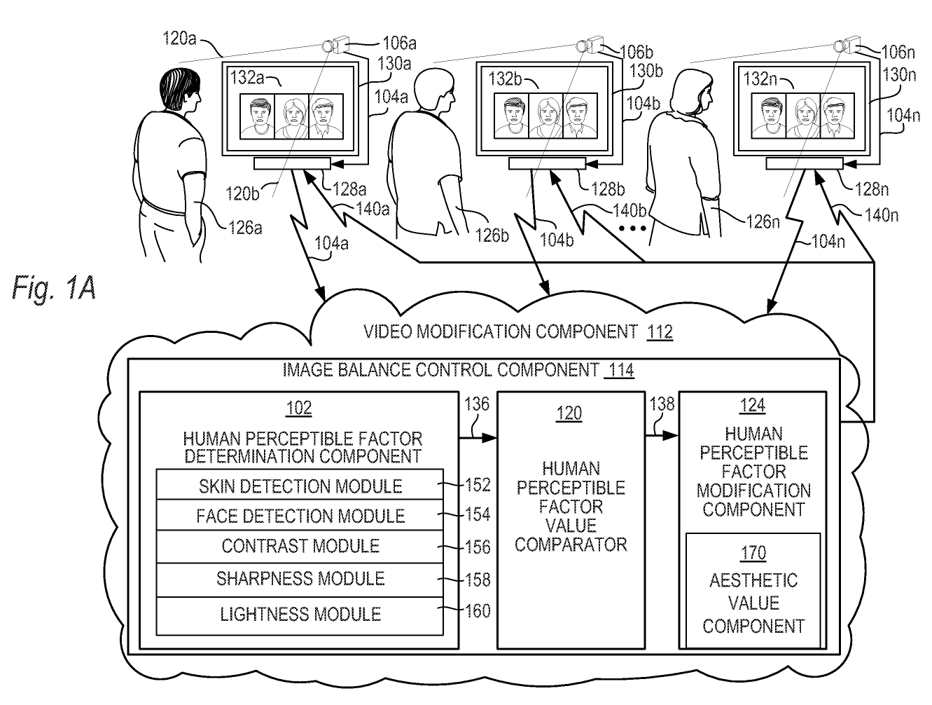

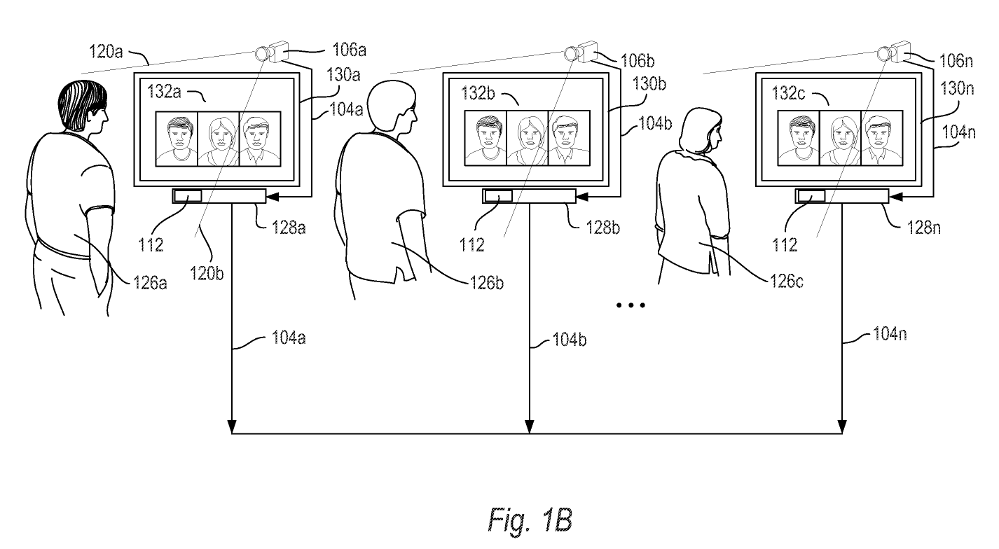

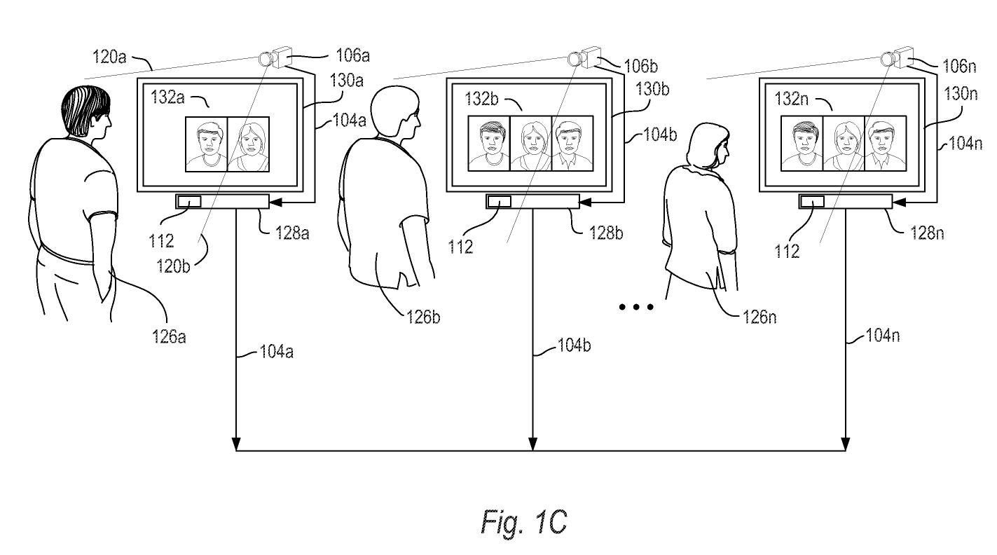

Referring to FIG. 1A shows a coordinated video modification system 112. In one embodiment, the video modification system and method is used in a multi-way (n-way) video conference. The system 112 receives input from a plurality of image capture devices 106a-n that are participating in a video conferencing session. The system shown is described with respect to n image capture devices 106a-n, where n is an integer value greater than one. For the implementation shown in FIG. 1A, n is equal to three. In the embodiment shown in FIG. 1A, each of the n video streams captures video of at least a single participant.

In one embodiment, each of the n image capture devices captures video of at least one video conference participant. Although more than one participant could be captured by the image capture devices, in the embodiment shown in FIG. 1A only a single participant is captured by each image capture device. In one embodiment, each video conference participant is shown in front of desktop computing device 128a-n. Although the participants are shown in front of a desktop computer, alternative video conferencing configurations and alternative video conferencing devices (capable of transmitting and receiving video images) can also occur. For example, a participant holding a mobile computing device with video capture capability could replace a subset or all of the video conferencing participants shown in FIG. 1A. Alternatively, additional participants in different video conferencing configurations may be added or deleted from the configuration shown in FIG. 1A in accordance with the invention. For example, participants in a configuration with strict configuration requirements (matching paint, image capture devices, backgrounds, etc.) could be added to the video conferencing session.

Referring to FIG. 1A, the display 130a-n of the computing devices is coupled to the computing device 128a-n and is shown displaying images 132a-n of each of the video conference participants 126a-n. In one embodiment, the output of the image capture devices 104a-n is coupled to the video modification component 112 through the computing devices 128a-n. In an alternative embodiment (not shown), the output from the image capture device is directly coupled from the image capture devices 106a-n to the video modification component 112.

Referring to FIG. 1A shows a human perceptible factor value determination component 102, for determining the value of at least one image modification factor, (a human perceptible factor) for at least a subset of the plurality of video streams 104a-n. Each video stream video may include several image modification factors or human perceptible factors that can be observed or perceived (human perceptible) and modified according to the present invention. Examples of human perceptible factors include but are not limited to: contrast, color (including color balance, etc.), noise level, and sharpness.

The human perceptible factor determination component includes a plurality of modules that could include but are not limited to: a skin detection module 152, a face detection module 154, a contrast module 156, a sharpness module 158, a lightness module 160). The “modules” and/or “components” in the described system can be implemented in hardware or software or a combination of both. Also, although an element may be shown as a single element, the modules or components can be combined with other components or modules to form a single module that performs the same function. Alternatively; a single module could be separated into multiple modules or components that perform the same function.

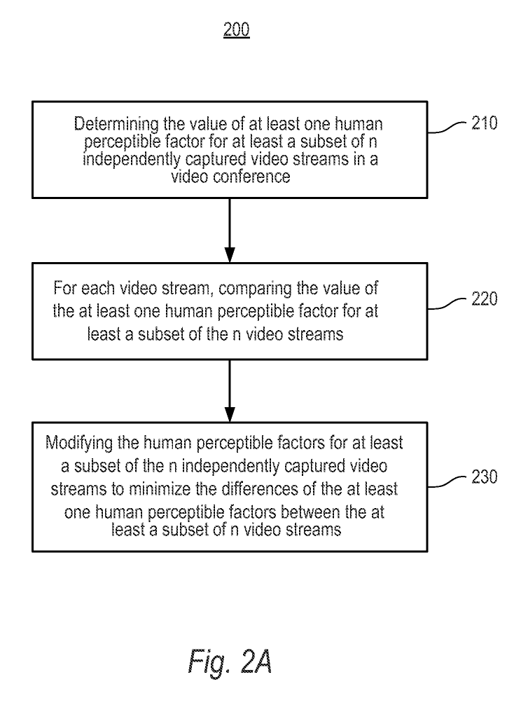

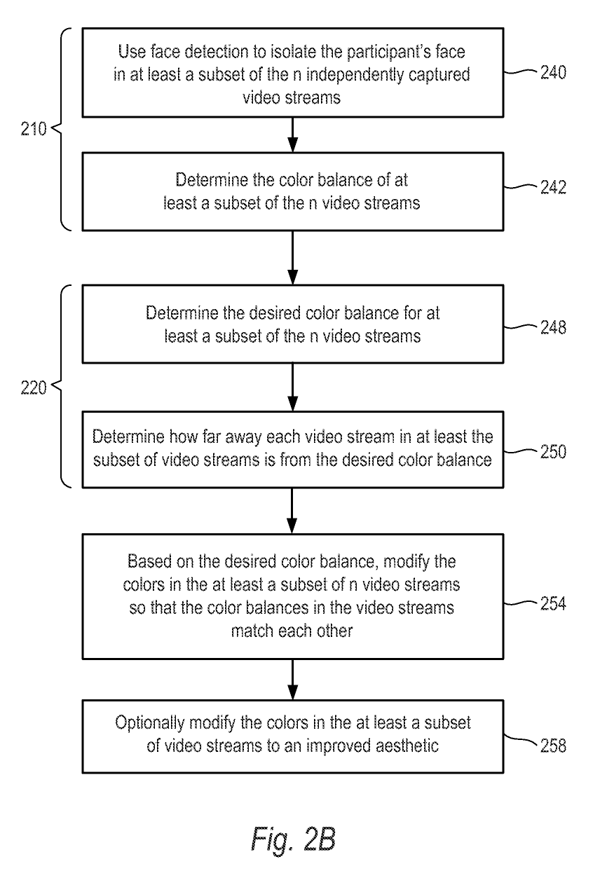

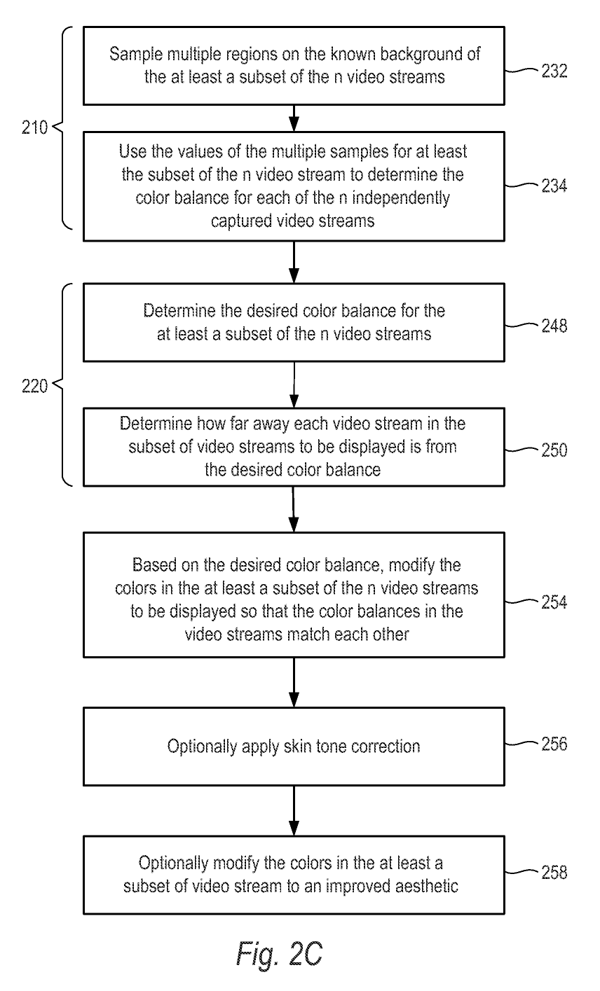

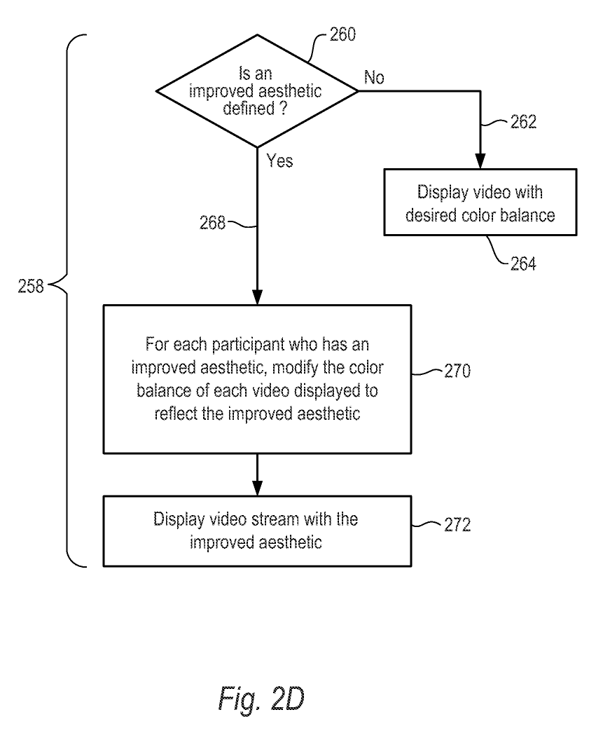

The video modification system compares at least one human perceptible quality in the video stream. In one embodiment, only one human perceptible quality is compared and modified. For example, for the embodiment described with respect to FIGS. 2B and 2C, only the color balance of the image is modified. In an alternative embodiment, the image sharpness might be modified. For example, the media transfer function of the lens of the image capture device can be characterized as a sharpness frequency response. Knowing this the video modification system according to the present invention; can compensate for each camera's imperfections and make the output of each independently captured video stream more consistent by minimizing the sharpness function between video streams. In addition, multiple human perceptible factors in the video streams can be modified. For example, in an alternative embodiment both the color balance and sharpness of the video streams could be modified to provide an improved video.

The human perceptible factor determination component 102 uses video information (captured by sensors, the video capture devices, etc.) and analyzes it in order to determine the human perceptible factor value. For example, a frame of the video can be analyzed and information from the video frame can be used to determine the color balance in the image. For example, the skin detection module 152 may be used to detect the skin of a video conference participant. In one example described with respect to FIG. 2B, the skin color of the video participants is used in making the determination of the desired color balance of the video stream.

Referring to FIG. 1A, after the determination of the human perceptible value, the at least one human perceptible values in the video streams are compared (step 220 in FIG. 2A). The output 136 (the human perceptible values) of the human factor value determination component 116 is used as input in the comparison. The values of the video streams are compared in the human perceptible factor value comparator component 120. The human perceptible factor value comparator 120 uses the methods described in further detail in FIGS. 2A-2C to determine the desired human perceptible value 138 which is used by the human perceptible modification component 124 to determine how each video should be modified to minimize the differences between the human perceptible values in the video streams.

The output 138 of the comparison of the human perceptible values is used as input to the human factor modification component. Based on the comparison of the human perceptible modifications in the video streams, the output of the video streams is modified (step 230 in FIG. 2A). The modified video images are output 140a-n to the display screens 130a-130c of the video participants. Because the video streams have been modified to minimize the differences of the human perceptible values in the independently captured video streams, the video streams displayed appear more consistent and natural to the video conference participants.

FIG. 1B illustrates a block diagram of an alternative configuration of the video modification system shown in FIG. 1A. In the embodiment shown in FIG. 1A, the output 104a-n of the video cameras is output to the video modification component 112, where the video modification component is located at a shared master site, for example a cloud site. In the embodiment shown in FIG. 1B, each local site 128a-n has a copy of the video modification component. In FIG. 1B instead of the output of the video cameras being directed towards a single remote master site as shown in FIG. 1A, video from each participant 126a-n is transmitted to and processed at each local site. Alternatively, processing of the method 200 shown in FIGS. 2A-2D could be shared between multiple local sites, multiple remote site or alternatively shared between both local and remote sites.

FIG. 2A illustrates a flow diagram of a method of coordinating and balancing human perceptible image quality factors of independently captured video streams in a multi-way video conference according to an embodiment of the present invention. The described method takes video pixel samples from the n independently captured video streams and uses information from the different video streams to adjust each individual stream that will be displayed so that all of the streams appear more natural and also appear to be captured under the same lighting conditions. The methodologies described with respect to FIGS. 2B and 2C are for the example of modifying video streams with respect to color balance. However, this described implementation is for purposes of example, and the method described with respect to FIG. 2A can also be used to with respect to other human perceptible factors (for example, brightness, contrast, etc.) which are also important to convey the feeling that everyone in the meeting is in the same physical space.

When all of the video streams are displayed on the display screen of the video participant's display screen, the human perceptible factors for each video stream are determined, compared and modified. However, when only a subset of the video streams are displayed, then it is not required that all n video streams be processed. Instead, only a subset (for example, only the video streams to be displayed) of the video streams are processed. This, for example, could be the case for the embodiment shown in FIG. 1C. FIG. 1C illustrates a block diagram of an alternative embodiment of the color balance control system for processing a plurality of independently captured video streams in a multi-way video conference shown in FIG. 1B where only a subset of the video streams is displayed on one of the participant's display screens. Referring to FIG. 1C shows an implementation where the display screen 130a for the participant 126a displays only two of the three participants. In this case, it is possible to process and display only a subset of video streams—in this case the video streams of the other two participants 126b and 126n. Alternatively, the video streams of all three participants (n=3) could be processed and only two of the three participants could be displayed as shown in FIG. 1C.

The method shown in FIG. 2A covers the cases where either all or a subset of the n video streams are processed according to the method of the present invention for possible display. The method 200 shown in FIG. 2A includes the steps of: determining the value of at least one human perceptible factor for at least a subset of the n video streams, where n is an integer greater than one, where the n video streams captured independently by at least n image capture devices (step 210); comparing the value of the at least one human perceptible factor for at least a subset of the n video streams (step 220); and based on the comparison, modifying the value of the human perceptible factor for the at least a subset of the n video streams to minimize the differences in the values of the human perceptible factor between the at least a subset of the n video streams (step 230). For the case where a subset of values are compared, the subset consists of more than one video stream.

The previous example describes the case where only a subset of the n independently captured video streams may be compared according to the method 200. In an alternative embodiment where all of the n video streams are displayed—for each of the n video streams, the human perceptible factors are determined, compared and modified. Where all of the n video streams are displayed, the video streams may be processed according to the method comprised of the following steps: determining the value of at least one human perceptible factor for each of the n video streams, where n is an integer greater than one, where the n video streams captured independently by at least n image capture devices (step 210); comparing the value of the at least one human perceptible factor for each of the n video streams (step 220); and based on the comparison, modifying the value of the human perceptible factor for each of the n video streams to minimize the differences in the values of the human perceptible factor between the n video streams (step 230).

In one embodiment of the described invention, at least a subset of the n video streams are processed jointly and automatically modified—instead of enhancing each of the video streams individually. For the case of two video streams—the two video streams could both be jointly processed together and compared at the same time t₁ to determine the appropriate color balance. In an alternative embodiment, the two video streams could be processed and average values compared for some time interval. For example, for the case where n=2 and color balance is the human perceptible factor—the two video streams could each be adjusted to minimize the differences between the two video streams. For example, if the first video stream has color balance RGB=[1 1.8] and the second video stream has a color balance RGB=[1 1.6], the color balances of both video streams could be modified to RGB=[1 1.7] to make the color balance in these video streams appear more consistent.

FIG. 2B illustrates a flow diagram of a method of modifying the color balance in a multi-way video conference according to an embodiment of the present invention. Referring to the embodiment shown in FIG. 2B, shows in more detail the method shown in FIG. 2A for the example where the human perceptible factor is color balance. The implementation described with respect to FIG. 2B provides improved color balance for the displayed video streams. Improved color balance is achieved by focusing on balancing of the skin tones on the faces of the video conferencing participants.

Referring to FIG. 2B shows a more detailed implementation of the method shown in FIG. 2A. Steps 240 and 242 in FIG. 2B correspond to step 210 in FIG. 2A—the step of determining the value of at least one human perceptible factor for each of the n independently captured video streams. However, in FIG. 2B the human perceptible factor is color balance, with the focus on balancing the color balance in the participant's faces.

In the method shown in FIG. 2B, after the n image capture devices capture the video streams, face detection is used to isolate the participant's face (or faces) in at least a subset of the independently captured video streams (step 242). Video conferencing applications typically have the constraint that the conference participant's′ face is of a roughly given size within a defined boundary. With this constraint, face detection software typically runs very efficiently to localize the video conference participant's face. Further, it is anticipated that the face detection software can be run every few video frames (say every 15 frames, for example) and still work well for the purposes of this invention. If face detection fails or provides unsatisfactory results, then the system can alternatively use motion detection, making the assumption that the captured movement (pixels in the video that are moving) is the movement of the video conference participant. After motion is detected, skin tone colored pixels are assumed to be the skin of the participant.

Once the video conference participant's face is detected, the color balance of at least a subset of the n video streams is determined (step 242) using facial features of the video conference participants. From the facial features in the video stream, the colors of the facial features (for example, skin pixels or pixels of the eye whites) are measured and used to determine the nominal color balance of the video based on the combined lighting and capture system used to capture the video stream of interest. In one embodiment, once the face is detected color balance is determined from the skin of the video conference participants. Once it is determined what part of the face is skin using skin detection techniques, nominally known skin tone colors are used in order to determine color balance in the video frame. In an alternative embodiment, the facial feature used to determine the color balance is the eyes. Once the face (and eyes) is detected, eye white detection is used to determine the color balance. Alternatively, one can apply an eye feature detector independent of a face detector. Nominally known eye white colors are used in order to determine color balance in the video frame. The white balancing can be done only if the face is detected, otherwise a default white balance can be used.

After the color balance of each of the n independently captured video stream is determined (step 242), the system jointly processes the n video streams to determine the desired color balance for at least a subset of the video stream (step 248). After determining the desired color balance for the video stream, the color balance of the video streams are compared in order to determine how far away each video stream is away from the desired color balance (step 250). Steps 248 and 250 in FIG. 2B correspond to step 220 in FIG. 2A—the step of comparing the value of the at least one human perceptible factor. In the embodiment described with respect to FIG. 2B the human perceptible factor is defined to be the color balance and the comparison made is the comparison between the video stream color balance values.

The balancing and comparison of the human perceptible factors can be described and optimized according to the present invention, with respect to equation (1):

$${argmin}_{{p}_{1} {p}_{2} {p}_{3}} {\sum }_{i} F ( T ( {f}_{i} , {p}_{i} ) ) + λ {\sum }_{i \neq j} G ( T ( {f}_{i} , {p}_{i} ) , T ( {f}_{j} , {p}_{j} ) ) \qquad ( 1 )$$

Where fᵢ represents the input frame for the video stream indexed by i and p are parameters of the transformation T of frame fᵢ. The transformation T corresponds to a human perceptible factor. Although equation (1) is applicable to different human perceptible factors, for purposes of the color balance example described, p is a parameter vector used to adjust the white balance function T, that maps input colors to output color. The term pᵢ represents the parameter we are comparing in order to minimize the expression in equation (1). The term F is an error criteria for keeping the results close to the target values, in the white balance function T and G is an error criteria that keeps the results of the white balancing for the different streams dose to each other. The relative importance given to the first term in the optimization versus the second term is controlled with the weight λ, for the implementation where we are trying to balance the human perceptible color balance.

Once the desired color balance value is determined, the values are compared to determine how far away the color balance value of each video stream is from the desired color balance value. Once this difference is known, it is used to minimize the differences between the color balance values of the different video streams. If the difference between the color balance values is zero (or small but non-zero because of random errors)—then the color balance values of the video streams match (to the extent possible using the described method). In the embodiment described with respect to FIG. 2B, this is done by modifying the colors in the video stream so that the color balance in at least a subset of the independent video streams match (step 254).

After the colors in the video are modified to the desired color balance (and optionally modified to apply skin tone correction (step 254)), the colors of at least a subset of the n video streams may be optionally be modified towards an improved aesthetic. The process of modifying the video stream to an improved aesthetic (step 258) is defined in more detail with respect to the implementation described with respect to FIG. 2D.

FIG. 2C illustrates a flow diagram of a method of modifying the color balance of the independently captured video streams in a multi-way video conference according to an embodiment of the present invention. The method described with respect to FIG. 2B addresses the common problem of poor color balance on the participant's faces. The implementation described with respect to FIG. 2C applies to the case where there are known backgrounds that are meant to match by design—for example, higher end systems where the video conference locations match by design through efforts to control the physical environment of the video conference location. In this case, cameras and lighting are specified to match each other and the differences between the different video streams are due to subtle differences in lighting, camera settings, paint tolerance, etc.—small background differences that are nonetheless visible and objectionable to the user viewing the displayed video of the multiple video conference locations.

Referring to the embodiment shown in FIG. 2C, shows in more detail the method shown in FIG. 2A for the case where the human perceptible factor is color balance and the video conferencing environments are designed to have common backgrounds. Similar to the embodiment shown in FIG. 2B, the embodiment shown in FIG. 2C is described with respect to color balance. However, instead of attempting to find color balance using facial (i.e. skin tones) attributes of the participants, the method shown in FIG. 2C attempts to provide color balance between the independent video streams by using the information regarding the background found in the videos. This technique is applicable for structured video conferencing situations where the background behind the video participants is a uniform predefined color background.

In the method shown in FIG. 2C, after the n image capture devices capture the video streams, multiple regions of the known background are sampled (step 232). The values of the multiple samples of the background are used to determine the nominal color balance of the n independently captured video streams (step 234).

Alter the color balance of each of the n independently captured video stream is determined (step 242), the system jointly processes the n video streams to determine the desired color balance for the video stream (step 248). After determining the desired color balance for the video stream, the color balance of the video streams are compared in order to determine how far away each video stream is away from the desired color balance (step 250). Steps 248 and 250 in FIG. 2C correspond to step 220 in FIG. 2A—the step of comparing the value of the at least one human perceptible factor. In FIG. 2C the human perceptible factor is defined to be the color balance and the comparison made is the comparison between the video stream color balances values of the background.

Once the desired color balance value is determined, the values are compared to determine how far away the color balance value of each video stream is from the desired color balance value. Once this difference is known, it is used to minimize the differences between the color balance values of the different video streams. If the difference between the color balance values is zero (or the minimized value(—then the color balance values of the video streams match.

After the colors in the video are modified to the desired color balance (and optionally modified to apply skin tone correction (step 254)), the colors of at least a subset of the n video streams may be optionally be modified towards an improved aesthetic. The process of modifying the video stream to an improved aesthetic (step 258) is defined in more detail with respect to the implementation described with respect to FIG. 2D.

FIG. 2D illustrates a flow diagram of a method of modifying the video streams according to an improved aesthetic in a multi-way video conference according to an embodiment of the present invention. Referring to FIG. 2D, after the human perceptible factor (in the implementation in FIGS. 2B and 2C color balance) is modified (step 254), at least a subset of the n video streams may optionally be modified towards an improved aesthetic. Although other human perceptible values than color balance may be modified, the implementation described with respect to FIG. 2D assumes that color balance is the human perceptible factor that is being coordinated for balance amongst the captured video streams.

In one embodiment, the first step in determining whether the video streams are modified towards an improved aesthetic is to determine whether an improved aesthetic is defined (step 260). In some cases, the improved aesthetic is a user or participant defined local system preference. For example, the video conference participant may want his personal or local system to have a color balance with more reddish tones than is standard. In this case, the more reddish “improved” aesthetic may be applied only to the video streams that are displayed on the local participant's display screen according to the local participant's specifications—while the other participants in the conference may display the standard color balance. In an alternative embodiment, the improved aesthetic may be a system defined aesthetic. For example, if the color balance that is the desired color balance is what the system defines as out of range aesthetically, the system may modify the color aesthetic of the desired color balance determined by the balance control component to be ideal.

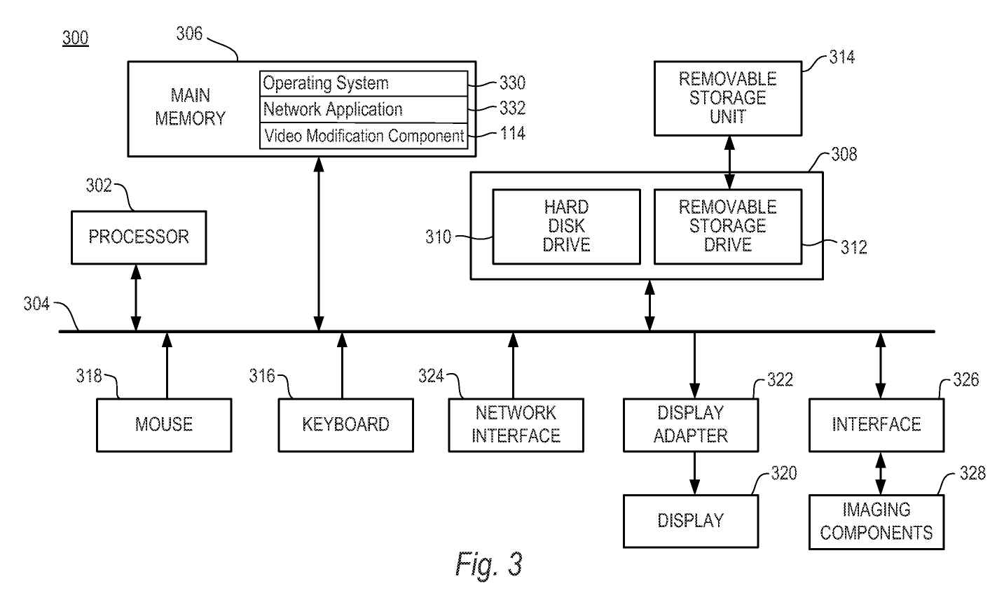

FIG. 3 shows a computer system for implementing the methods shown in FIGS. 2A-2D and described in accordance with embodiments of the present invention. Although the methods described in FIGS. 2A-2D can be implemented in software as post-processing on the video streams, in another embodiment part or all of the steps could be implemented in hardware. For example, in an alternative embodiment, instead of modifying the human perceptible values in the video images themselves using software, at least some of the human perceptible values in the video streams could modified by modifying the human perceptible factor values in the physical environment of the video conferencing session. This could be a hardware implementation, for example, where a dimmer switch acts as the image modification component to modify the lighting environment of the room or location where the video conference occurs. In one embodiment, after measuring the human perceptible values in both video streams it might be determined that there is a difference between the two video streams. In order to minimize this difference, the dimmer switch position in one or both of the rooms where the video conference is occurring could be modified to minimize the human perceptible factor (lighting differences) found in the video that is captured at the video conferencing locations.

FIG. 3 shows a computer system for implementing the methods shown in FIGS. 2A-2D and described in accordance with embodiments of the present invention. It should be apparent to those of ordinary skill in the art that the method 200 represents generalized illustrations and that other steps may be added or existing steps may be removed, modified or rearranged without departing from the scopes of the method 200. The descriptions of the method 200 are made with reference to the system 112 illustrated in FIG. 1A-1D and thus refers to the elements cited therein. It should, however, be understood that the method 200 is not limited to the elements set forth in the system 112. Instead, it should be understood that the method 200 may be practiced by a system having a different configuration than that set forth in the system 112.

Some or all of the operations set forth in the method 200 may be contained as utilities, programs or subprograms, in any desired computer accessible medium. In addition, the method 200 may be embodied by computer programs, which may exist in a variety of forms both active and inactive. For example, they may exist as software program(s) comprised of program instructions in source code, object code, executable code or other formats. Any of the above may be embodied on a computer readable medium, which include storage devices and signals, in compressed or uncompressed form.

FIG. 3 illustrates a block diagram of a computing apparatus 300 configured to implement or execute the methods 200 depicted in FIGS. 2A-2D and described in accordance with embodiments of the present invention. In this respect, the video modification component 112 may be used as a platform for executing one or more of the functions described hereinabove.

The computing apparatus 300 includes one or more processor(s) 302 that may implement or execute some or all of the steps described in the methods 200. Commands and data from the processor 302 are communicated over a communication bus 304. The computing apparatus 300 also includes a main memory 306, such as a random access memory (RAM), where the program code for the processor 302, may be executed during runtime, and a secondary memory 308. The secondary memory 308 includes, for example, one or more hard drives 310 and/or a removable storage drive 312, representing a removable flash memory card, etc., where a copy of the program code for the method 200 may be stored. The removable storage drive 312 reads from and/or writes to a removable storage unit 314 in a well-known manner.

These methods, functions and other steps may be embodied as machine readable instructions stored on one or more computer readable mediums, which may be non-transitory. Exemplary non-transitory computer readable storage devices that may be used to implement the present invention include but are not limited to conventional computer system RAM, ROM, EPROM, EEPROM and magnetic or optical disks or tapes. Concrete examples of the foregoing include distribution of the programs on a CD ROM or via Internet download. In a sense, the Internet itself is a computer readable medium. The same is true of computer networks in general. It is therefore to be understood that any electronic device and/or system capable of executing the functions of the above-described embodiments are encompassed by the present invention.

Although shown stored on main memory 306, any of the memory components described 306, 308, 314 may also store an operating system 330, such as Mac OS, MS Windows, Unix, or Linux; network applications 332; and a balance control component 334. The operating system 330 may be multi-participant, multiprocessing, multitasking, multithreading, real-time and the like. The operating system 330 may also perform basic tasks such as recognizing input from input devices, such as a keyboard or a keypad; sending output to the display 320; controlling peripheral devices, such as disk drives, printers, image capture device; and managing traffic on the one or more buses 304. The network applications 332 includes various components for establishing and maintaining network connections, such as software for implementing communication protocols including TCP/IP, HTTP, Ethernet, USB, and FireWire.

The computing apparatus 300 may also include an input devices 316, such as a keyboard, a keypad, functional keys, etc., a pointing device, such as a tracking ball, cursors, etc., and a display(s) 320, such as the LCD screen display 130 shown for example in FIG. 1A. A display adaptor 322 may interface with the communication bus 304 and the display 320 and may receive display data from the processor 302 and convert the display data into display commands for the display 320.

The processor(s) 302 may communicate over a network, for instance, a cellular network, the Internet, LAN, etc., through one or more network interfaces 324 such as a Local Area Network LAN, a wireless 802.11x LAN, a 3G mobile WAN or a WiMax WAN. In addition, an interface 326 may be used to receive an image or sequence of images from imaging components 328 such as the image capture device.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purposes of illustration and description. They are not intended to be exhaustive of or to limit the invention to the precise forms disclosed. Obviously, many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

What is claimed is:

1. A method of modifying video comprising the steps of:
determining, by a processor, the value of at least one human perceptible factor for at least a subset of the n video streams, where n is an integer greater than one, wherein the n video streams are independently captured by at least n image capture devices;
comparing the value of the at least one human perceptible factor for at least a subset of the n video streams; and
based on the comparison, modifying the value of the human perceptible factor for the at least a subset of the n video streams to minimize the differences in the values of the human perceptible factor between the at least a subset of the n video streams.

2. The method recited in claim 1 further including the step of displaying at least a subset of the modified video streams.

3. The method recited in claim 1 further including the step of optionally modifying at least a subset of the video streams to an improved aesthetic.

4. The method recited in claim 1 wherein the step of comparing the value of the at least one human perceptible factor for at least a subset of the n video streams includes the steps of determining the desired human perceptible factor value for the at least a subset of the n video streams.

5. The method recited in claim 4 wherein the desired value human perceptible values p₁, p₂, . . . pₙ are determined based on the equation
$${argmin}_{{p}_{1} {p}_{2} {p}_{3}} {\sum }_{i} F ( T ( {f}_{i} , {p}_{i} ) ) + λ {\sum }_{i \neq j} G ( T ( {f}_{i} , {p}_{i} ) , T ( {f}_{j} , {p}_{j} ) ) .$$
where
i and j are the indices of the video streams being compared,
fᵢ represents the input frame for the video stream indexed by i,
pᵢ is a parameter vector of the transformation function,
T is a transformation function,
F is an error criteria for keeping the results dose to the target values,
G is the error criteria that keeps the results of the white balancing for the different streams dose to each other, and
λ is the relative weight given to the second term versus the first term in the optimization.

6. The method recited in claim 1 wherein the human perceptible factor is color balance.

7. The method recited in claim 6, wherein face detection is used to isolate the participant's face in at least a subset of the n video streams.

8. The method recited in claim 7, further including the step of determining the color balance of the participant's face in at least a subset of the n video streams.

9. A system for modifying video streams, the system comprised of:
a human factor value determination component executed by a processor, for determining the value of at least the human perceptible factor for at least a subset of the plurality of video streams, wherein the plurality of video streams are each captured independently by at least n image capture devices;
a human factor value comparator component for comparing the value of the at least one human perceptible factor for at least a subset of the plurality of the video streams; and
a human factor modification component for modifying the value of the human perceptible factor for at least a subset of the plurality of video streams to minimize the differences in the values of the human perceptible factor between the at least a subset of the plurality of video streams.

10. The system recited in claim 9 further including the step of displaying at least a subset of the modified video streams.

11. The system recited in claim 10 further including the step of optionally modifying at least a subset of the video streams to an improved aesthetic.

12. The system recited in claim 11 wherein the step of comparing the value of the at least one human perceptible factor for at least a subset of the n video streams includes the steps of determining the desired human perceptible factor value for the at least a subset of the n video streams.

13. A non-transitory computer readable storage medium having computer readable program instructions stored thereon for causing a computer system to perform instructions, the instructions comprising the steps of:
determining the value of at least one human perceptible factor for at least a subset of the n video streams, where n is an integer greater than one, where the n video streams captured independently by at least n image capture devices, each of the n image capture devices capturing video of at least a single participant;
comparing the value of the at least one human perceptible factor for at least a subset of the n video streams; and
based on the comparison, modifying the value of the human perceptible factor for the at least a subset of the n video streams to minimize the differences in the values of the human perceptible factor between the at least a subset of the n video streams.

14. The computer readable storage medium recited in claim 13 further including the step of displaying at least a subset of the modified video streams.

15. The computer readable storage medium recited in claim 13 further including the step of optionally modifying at least a subset of the video streams to an improved aesthetic.

16. The computer readable storage medium recited in claim 13 wherein the step of comparing the value of the at least one human perceptible factor for at least a subset of the n video streams includes the steps of determining the desired human perceptible factor value for the at least a subset of the n video streams.

17. The computer readable storage medium recited in claim 13 wherein the desired value human perceptible values p₁, p₂, . . . pₙ are determined based on the equation
$${argmin}_{{p}_{1} {p}_{2} {p}_{3}} {\sum }_{i} F ( T ( {f}_{i} , {p}_{i} ) ) + λ {\sum }_{i \neq j} G ( T ( {f}_{i} , {p}_{i} ) , T ( {f}_{j} , {p}_{j} ) ) .$$
where
i and j are the indices of the video streams being compared,
fᵢ represents the input frame for the video stream indexed by i,
pᵢ is a parameter vector of the transformation function,
T is a transformation function,
F is an error criteria for keeping the results close to the target values,
G is the error criteria that keeps the results of the white balancing for the different streams close to each other, and
λ is the relative weight given to the second term versus the first term in the optimization.

18. The computer readable storage medium recited in claim 13 wherein the human perceptible factor is color balance.

19. The computer readable storage medium recited in claim 18, wherein each of the n image capture devices capturing video of at least a single participant and face detection is used to isolate the participant's face in at least a subset of the n video streams.

20. The computer readable storage medium recited in claim 19, further including the step of determining the color balance of the participant's face in at least a subset of the n video streams.
